(19) United States
(12) Patent Application Publication
(10) Pub. No.: US 2022/0417866 A1
(43) Pub. Date: Dec. 29, 2022

(54) COMMUNICATION SYSTEM, WIRELESS CONNECTION METHOD, AND WIRELESS DEVICE

(71) Applicant: Panasonic Intellectual Property Management Co., Ltd., Osaka (JP)

(72) Inventors: Kazuki HASHIMOTO, Osaka (JP); Akira YAMASAKI, Osaka (JP)

(21) Appl. No.: 17/846,325

(22) Filed: Jun. 22, 2022

(30) Foreign Application Priority Data
Jun. 23, 2021 (JP) 2021-104258

(51) Int. Cl. H04W 52/28; H04W 64/00; H04W 16/28

(52) U.S. Cl. CPC H04W 52/283; H04W 64/006; H04W 16/28; H04N 5/23296

(57) ABSTRACT

A communication system includes a wireless device configured to perform wireless connection with another wireless device, and an information processing device connected to the wireless device. The information processing device displays a captured image in which a reception direction of a radio wave of the wireless device is captured, and in a case that an operation of changing a display of the captured image is performed by a user, transmits information generated by the operation to the wireless device. The wireless device changes a reception range of the radio wave based on the information received from the information processing device.

### CROSS-REFERENCE TO RELATED APPLICATIONS

This application is based on and claims priority under 35 USC 119 from Japanese Patent Application No. 2021-104258 filed on Jun. 23, 2021, the contents of which are incorporated herein by reference.

### TECHNICAL FIELD

The present disclosure relates to a communication system, a wireless connection method, and a wireless device.

### BACKGROUND ART

When wireless communication is performed, it is known that communication quality is improved by matching a direction of a directional beam of a radio wave transmitted or received by an antenna with a direction of a communication partner.

JP-A-2001-103002 discloses that an image of vicinity of a wireless terminal device is captured by a camera included in the wireless terminal device, a communication partner station such as a base station is found from the captured image data, a direction of the communication partner station is estimated, and a directional beam of a radio wave transmitted or received by an antenna is directed to the estimated direction.

However, when a distance to the communication partner is long, it may not be possible to wirelessly connect to the communication partner only by directing the directional beam toward the communication partner.

### SUMMARY OF INVENTION

An object of the present disclosure is to provide a technique capable of easily performing wireless connection not only when a distance to a communication partner is short but also when a distance to the communication partner is long.

Aspect of non-limiting embodiments of the present disclosure relates to provide a communication system including: a wireless device configured to perform wireless connection with another wireless device; and an information processing device connected to the wireless device. The information processing device displays a captured image in which a reception direction of a radio wave of the wireless device is captured, and in a case that an operation of changing a display of the captured image is performed by a user, transmits information generated by the operation to the wireless device. The wireless device changes a reception range of the radio wave based on the information received from the information processing device.

Another aspect of non-limiting embodiments of the present disclosure relates to provide a wireless connection method for wirelessly connecting a wireless device to another wireless device. The wireless connection method includes: displaying, by an information processing device, a captured image in which a reception direction of a radio wave of the wireless device is captured, in a case that an operation of changing a display of the captured image is performed by a user and transmitting information generated by the operation to the wireless device, and changing by the wireless device, a reception range of the radio wave based on the information received from the information processing device, and performing, by the wireless device, wireless connection with another wireless device.

Further aspect of non-limiting embodiments of the present disclosure relates to provide a wireless device configured to perform wireless connection with another wireless device, the wireless device including: a plurality of antenna elements; and a processor configured to, in response to receiving from a predetermined information processing device information generated by an operation of changing a display of a captured image in which a reception direction of a radio wave received by the antenna element is captured, change a reception range of the radio wave based on the received information.

These comprehensive or specific aspects may be implemented by a system, a device, a method, an integrated circuit, a computer program, or a recording medium, or may be implemented by any combination of the system, the device, the method, the integrated circuit, the computer program, and the recording medium.

According to the present disclosure, it is possible to easily perform wireless connection not only when a distance to a communication partner is short but also when a distance to the communication partner is long.

### BRIEF DESCRIPTION OF DRAWINGS

FIG. 1 is a conceptual diagram for explaining wireless connection between an AP and an STA.

FIG. 2 is a block diagram showing a configuration example of a communication system according to the present embodiment.

FIG. 3 is a block diagram showing a configuration example of a wireless module according to the present embodiment.

FIG. 4 is a diagram showing an example of antenna pattern information according to the present embodiment.

FIG. 5 is a diagram showing an example of conversion information according to the present embodiment.

FIG. 6 is a sequence chart showing an example of a wireless connection method according to the present embodiment.

FIG. 7 is a view showing an example of attachment of a smartphone to the STA according to the present embodiment.

FIGS. 8A to 8C are views showing examples of an adjustment UI image displayed on a display device of the smartphone according to the present embodiment.

### DESCRIPTION OF EMBODIMENT

Hereinafter, an embodiment of the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy in the following description and to facilitate understanding for those skilled in the art. The accompanying drawings and the following description are provided for those skilled in the art to fully understand the present disclosure, and are not intended to limit the subject matter described in the claims.

### Present Embodiment

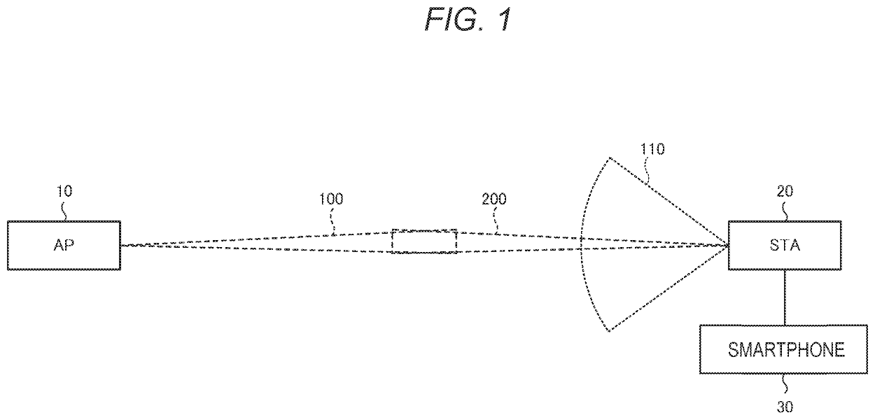

FIG. 1 is a conceptual diagram for explaining wireless connection between an access point (AP) 10 and a station (STA) 20. FIG. 1 is a plan view of the AP 10 and the STA 20 as viewed from above.

As shown in FIG. 1, a communication system 1 includes the AP 10, the STA 20, and a smartphone 30. The AP 10 may be read as a first wireless device, and the STA 20 may be read as a second wireless device. When the first wireless device and the second wireless device are not distinguished from each other, the first wireless device and the second wireless device may be simply referred to as a wireless device. The smartphone 30 may be read as an information processing device.

The AP 10 and the STA 20 are capable of millimeter wave communication, which is an example of wireless communication, and have a beamforming function. That is, the AP 10 and the STA 20 can set a directional beam for a radio wave transmitted or received by a plurality of antenna elements 44. A wavelength band of the radio wave used by the AP 10 and the STA 20 for the wireless communication is not limited to a millimeter wave band, and may be any wavelength band.

In the related art, when the AP 10 and the STA 20 installed at positions separated from each other are wirelessly connected (that is, a wireless link is established), the following steps (S1) to (S2) are performed. (S1) The AP 10 transmits a beacon with a directional beam 100. (S2) The STA 20 receives the beacon transmitted by the directional beam 100 of the AP 10 using a pseudo omni pattern 110, and is wirelessly connected to the AP 10.

The pseudo omni pattern 110 has a reception range (reception angle) wider than that of the directional beam, but has a reception gain lower than that of the directional beam. Therefore, there may be a case that a sum of a transmission gain of the AP 10, a reception gain of the STA 20, and a propagation loss between the AP 10 and the STA 20 (however, the propagation loss is a negative value) does not exceed a reception sensitivity of the STA 20 and communication cannot be established.

On the other hand, the reception gain of the STA 20 is increased by setting a directional beam 200 having a narrow reception range (reception angle) in the STA 20. Therefore, the STA 20 can be wirelessly connected to the AP 10 located farther away from the STA 20. However, it is difficult to adjust the reception range of the directional beam 200 of the STA 20 to a transmission range of the directional beam 100 of the AP 10 such that the STA 20 can receive the beacon transmitted by the directional beam 100 from the AP 10.

Therefore, a communication system, a wireless connection method, and a wireless device that can easily perform wireless connection between the AP 10 and the STA 20 not only when a distance between the AP 10 and the STA 20 is short but also when a distance between the AP 10 and the STA 20 is long will be described below.

### <Configuration of Communication System>

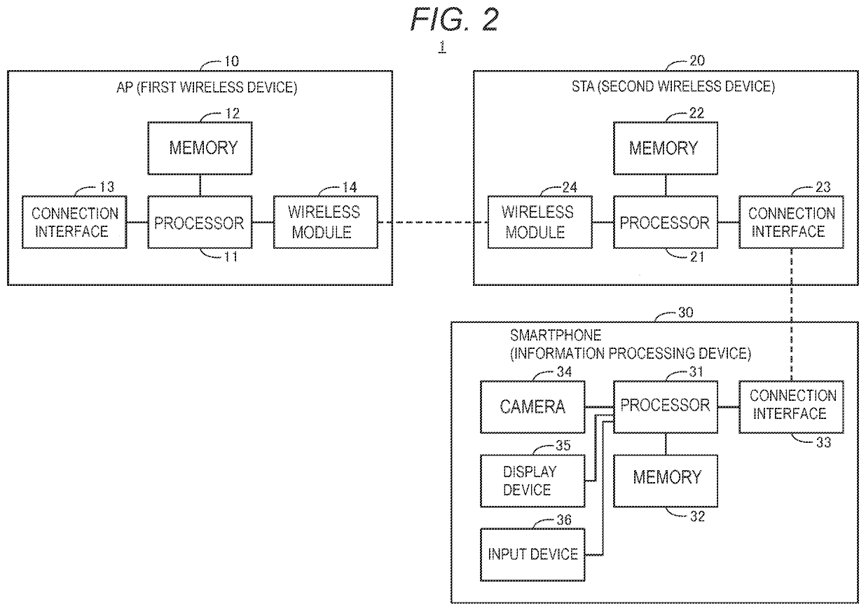

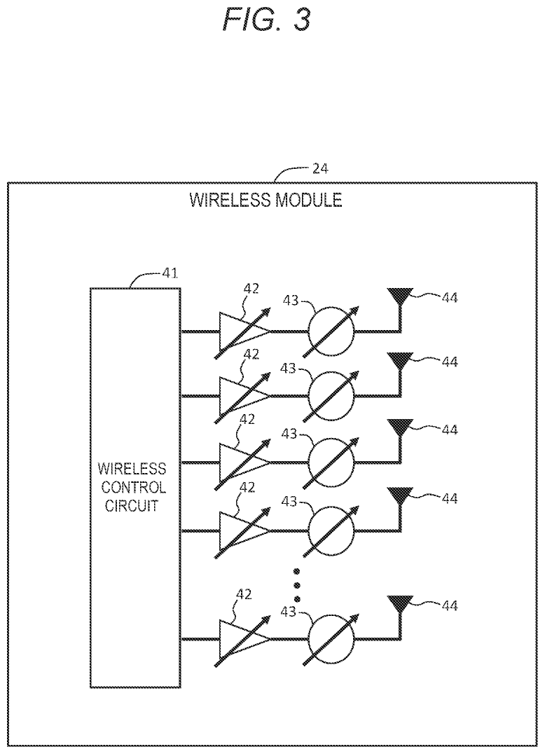

FIG. 2 is a block diagram showing a configuration example of the communication system 1 according to the present embodiment. FIG. 3 is a block diagram showing a configuration example of a wireless module 24 according to the present embodiment.

The AP 10 (first wireless device) includes a processor 11, a memory 12, a connection interface 13, and a wireless module 14. The STA 20 (second wireless device) includes a processor 21, a memory 22, a connection interface 23, and a wireless module 24. As shown in FIG. 2, the AP 10 and the STA 20 may have the same configuration. Therefore, in description of FIGS. 2 and 3, components of the STA 20 will be described, and the description of components of the AP 10 will be omitted.

The processor 21 is configured using, for example, a central processing unit (CPU), a micro processing unit (MPU), a digital signal processor (DSP), or a field programmable gate array (FPGA). The processor 21 executes control processing for totally controlling operations of the units 22 to 24 of the STA 20.

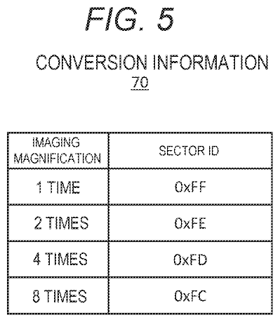

The memory 22 may include a read-only memory (ROM), a random access memory (RAM), a flash memory, or the like, and stores various programs executed by the processor 21 and various types of data. For example, the memory 22 stores conversion information 70 shown in FIG. 5.

The connection interface 23 is an interface for connecting an external device such as the smartphone 30. The connection interface 23 includes a communication circuit corresponding to wired communication or wireless communication. An example of the connection interface 23 for wired communication is a universal serial bus (USB) interface. Examples of the connection interface 23 for wireless communication include an interface for Wi-Fi (registered trademark) communication and an interface for Bluetooth (registered trademark) communication.

As shown in FIG. 3, the wireless module 24 includes a wireless control circuit 41 that processes a wireless signal, a plurality of gain adjustment circuits 42, a plurality of phase adjustment circuits 43, and a plurality of antenna elements 44. The plurality of antenna elements 44 may be read as array antennas.

As shown in FIG. 3, one gain adjustment circuit 42 and one phase adjustment circuit 43 are associated with one antenna element 44. The wireless control circuit 41 can realize the directional beams 200 of various patterns by adjusting a gain value and a phase value of a signal by the gain adjustment circuit 42 and the phase adjustment circuit 43 associated with each antenna element 44. For example, the wireless control circuit 41 can increase a reception gain by narrowing the reception range (reception angle) of the directional beam 200, or can decrease a reception gain by widening the reception range (reception angle) of the directional beam 200. In addition, the wireless control circuit 41 may change a direction of the directional beam 200 up, down, left, and right.

The smartphone 30, which is an example of an information processing device, includes a processor 31, a memory 32, a connection interface 33, a camera 34, a display device 35, and an input device 36.

The processor 31 is configured using, for example, a CPU, an MPU, a DSP, or an FPGA. The processor 31 executes control processing for totally controlling operations of the units 32 to 36 of the smartphone 30.

The memory 32 may include a ROM, a RAM, a flash memory, or the like, and stores various programs executed by the processor 31 and various types of data. For example, the memory 32 stores an adjustment UI program to be described later.

The connection interface 33 is an interface for connecting the smartphone 30 to the STA 20. The connection interface 33 includes a communication circuit corresponding to wired communication or wireless communication. An example of the connection interface 33 for wired communication is a USB interface. Examples of the connection interface 33 for wireless communication include an interface for Wi-Fi communication and an interface for Bluetooth communication.

The camera 34 includes a lens and an imaging element, and captures an image. The camera 34 may include a zoom mechanism. The camera 34 may be read as an imaging device. Instead of or in addition to the zoom mechanism, the processor 31 may have a digital zoom processing function.

The display device 35 is a device that displays an image. The display device 35 is, for example, a liquid crystal display or an organic EL display.

The input device 36 is a device that detects an input operation from an operator, which is an example of a user. The input device 36 is, for example, a touch panel, a button, a switch, a bar, a keyboard, a mouse, and/or a microphone.

### <Antenna Pattern Information>

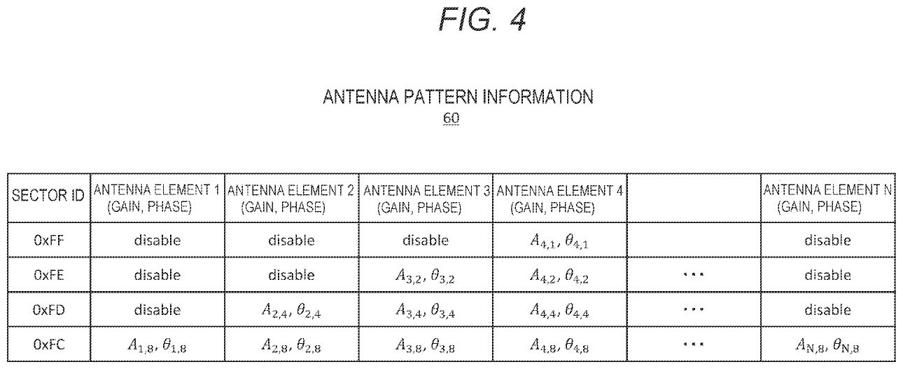

FIG. 4 shows an example of antenna pattern information 60 according to the present embodiment.

The antenna pattern information 60 is information indicating a correspondence relationship between combinations of a gain value and a phase value of each antenna element 44 and sector IDs. The antenna pattern information 60 may be stored in the wireless control circuit 41 of the wireless module 24. However, the antenna pattern information 60 may be stored in the memory 22.

In FIG. 4, “disable” indicates that the corresponding antenna element 44 is not used, “A_{m, n}” (m and n are integers of 1 or larger) indicates a gain value set in the gain adjustment circuit 42 corresponding to the corresponding antenna element 44, and “θ_{m, n}” indicates a phase value set in the phase adjustment circuit 43 corresponding to the corresponding antenna element 44.

When the sector IDs are different, the antenna pattern information 60 may be set such that at least one of the reception range (reception angle) and the reception gain of the directional beam 200 is different.

For example, in the antenna pattern information 60 shown in FIG. 4, a combination of a gain value and a phase value of each antenna element 44 associated with a sector ID “0xFF” is set such that a reception range (reception angle) of the directional beam 200 is the widest and a reception gain thereof is the lowest, and the reception range of the directional beam 200 becomes narrower and the reception gain thereof becomes higher in an order of a sector ID “0xFE”, a sector ID “0xFD”, and a sector ID “0xFC”.

### <Conversion Information>

FIG. 5 shows an example of the conversion information 70 according to the present embodiment.

The conversion information 70 is information indicating a correspondence relationship between imaging magnifications of the camera 34 and the sector IDs. The conversion information 70 may be stored in the memory 22 of the STA 20.

The conversion information 70 may be set such that the imaging magnification of the camera 34 is associated with the sector ID in which the reception range (reception angle) of the directional beam 200 becomes narrower and the reception gain thereof becomes higher as the imaging magnification of the camera 34 becomes larger. In other words, the conversion information 70 may be set such that the imaging magnification of the camera 34 is associated with the sector ID in which the reception range (reception angle) of the directional beam 200 becomes wider and the reception gain thereof becomes lower as the imaging magnification of the camera 34 becomes smaller.

For example, in the conversion information 70 shown in FIG. 5, the sector ID “0xFF”, in which a reception range (reception angle) of the directional beam 200 is the widest and a reception gain thereof is the lowest, is associated with an imaging magnification “1 time” of the camera 34, and the sector ID “0xFE”, the sector ID “0xFD”, and the sector ID “0xFC” are respectively associated with imaging magnifications “2 times”, “4 times”, and “8 times” of the camera 34 in this order such that the reception range of the directional beam 200 becomes narrower and the reception gain thereof becomes higher.

### <Wireless Connection Method>

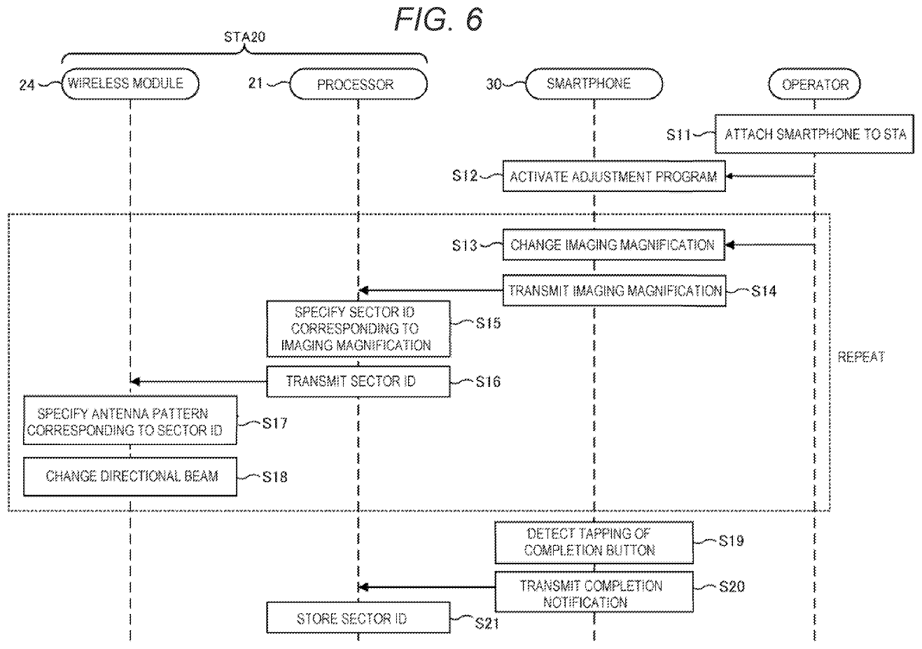

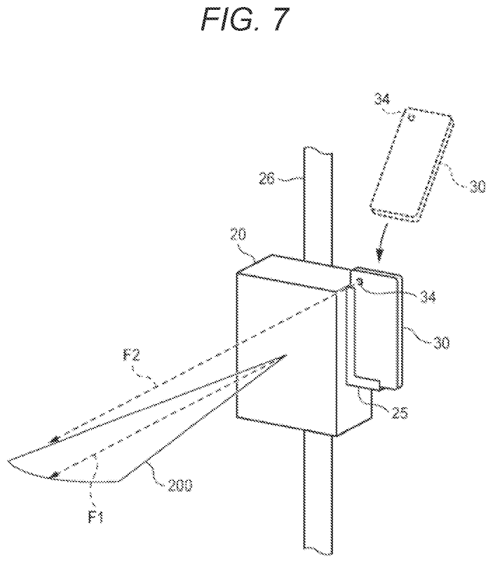

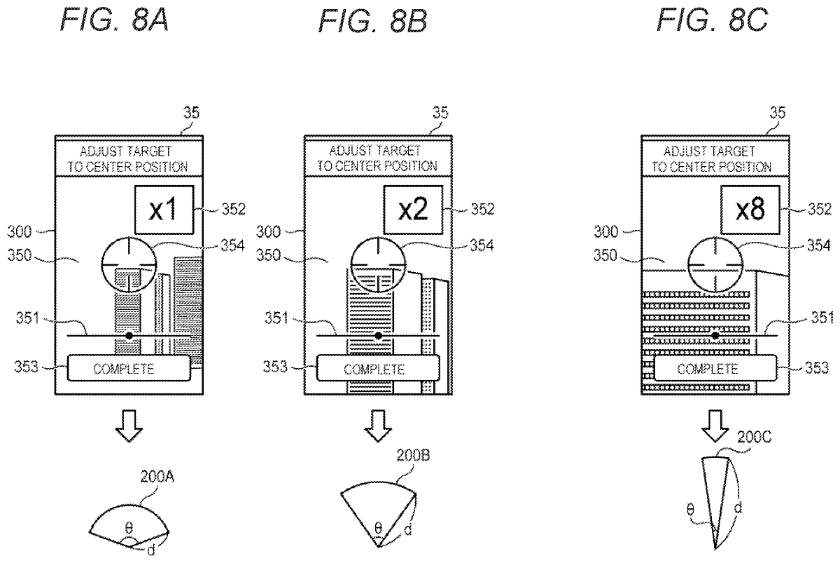

FIG. 6 is a sequence chart showing an example of a wireless connection method according to the present embodiment. FIG. 7 is a view showing an example of attachment of the smartphone 30 to the STA 20 according to the present embodiment. FIGS. 8A to 8C are views showing examples of an adjustment UI image 300 displayed on the display device 35 of the smartphone 30 according to the present embodiment.

As shown in FIG. 7, the STA 20 may be fixed at a predetermined height position of a pole 26 extending in a height direction, and a direction F1 of the directional beam 200 of the STA 20 may be a horizontal direction. When fixing the STA 20 to the pole 26, the operator may adjust the direction F1 of the directional beam 200 of the STA 20 so as to face a direction of the AP 10. For example, the operator horizontally rotates (axially rotates) the STA 20 about an axis of the pole 26 such that the STA 20 faces the direction of the AP 10, and fixes the STA 20 to the pole 26.

The operator attaches the smartphone 30 to an adapter 25 of the STA 20 (step S11). As shown in FIG. 7, the adapter is configured such that, when the smartphone 30 is attached, the camera 34 of the smartphone 30 faces a direction F2 (that is, the direction F1 of the directional beam 200) in which a reception direction of a radio wave by an array antenna of the STA 20 is captured. For example, as shown in FIG. 7, the adapter 25 may be configured such that the smartphone 30 can be slid from above and attached.

The operator starts the adjustment UI program of the smartphone 30 (step S12). Accordingly, as shown in FIGS. 8A to 8C, the adjustment UI image 300 is displayed on the display device 35 of the smartphone 30. As shown in FIGS. 8A to 8C, the adjustment UI image 300 may display a captured image 350 of the camera 34, a magnification operation bar 351 for adjusting the imaging magnification of the camera 34, a magnification image 352 indicating the imaging magnification of the camera 34, a completion button 353 for completing adjustment of the imaging magnification, and a center mark 354 indicating a center position of the captured image. In the present embodiment, an example is described in which all the components of the adjustment UI program are recorded in the smartphone 30 and started, but the scope of the present disclosure is not limited thereto. For example, a part or all of the adjustment UI program may be executed in another information processing device. Further, the smartphone 30 may transmit necessary information such as the imaging magnification to the STA 20 via another piece of information processing.

The operator performs an operation of changing a display of the captured image 350. For example, the operator operates the magnification operation bar 351 to change (for example, enlarge or reduce) the imaging magnification of the camera 34 (step S13). A change of the imaging magnification may be a change of optically enlarging or reducing the captured image by physically adjusting a lens position of the camera 34, or may be a change of digitally enlarging or reducing the captured image displayed on the display device 35.

The smartphone 30 transmits information indicating the changed imaging magnification of the camera 34 to the STA 20 (step S14).

The processor 21 of the STA 20 specifies the sector ID corresponding to the imaging magnification transmitted from the smartphone 30 with reference to the conversion information 70 (step S15).

The processor 21 of the STA 20 transmits the specified sector ID to the wireless module 24 (step S16).

The wireless control circuit 41 of the wireless module 24 receives the sector ID transmitted from the processor 21 in step S16, and specifies an antenna pattern corresponding to the received sector ID with reference to the antenna pattern information 60 (step S17). As described above, the antenna pattern may be the combination of the gain value and the phase value of each antenna element 44.

The wireless control circuit 41 of the wireless module 24 sets the gain value and the phase value of each antenna element 44 indicated by the specified antenna pattern in the gain adjustment circuit 42 and the phase adjustment circuit 43 of each antenna element 44, respectively, thereby changing a reception range (reception angle θ) and a reception gain d of the directional beam 200 as shown in FIGS. 8A to 8C (step S18).

The processing from step S14 to step S18 may be repeatedly executed every time the operator changes the imaging magnification of the camera 34 in step S13.

For example, when the operator sets the imaging magnification to “1 time” in step S13 as shown in FIG. 8A, the STA 20 sets a directional beam 200A having a relatively wide reception range (reception angle θ) and a relatively low reception gain d in steps S17 and S18. For example, when the operator sets the imaging magnification to “2 times” in step S13 as shown in FIG. 8B, the STA 20 sets a directional beam 200B having a reception range (reception angle θ) narrower and a reception gain d higher than those when the imaging magnification is “1 time” in steps S17 and S18. For example, when the operator sets the imaging magnification to “8 times” in step S13 as shown in FIG. 8C, the STA 20 sets a directional beam 200C having a reception range (reception angle θ) narrower and a reception gain d higher than those when the imaging magnification is “2 times” in steps S17 and S18.

In this way, the operator can easily adjust the reception range (reception angle θ) and the reception gain d of the directional beam 200 of the STA 20 by adjusting the imaging magnification of the camera 34 of the smartphone 30. For example, the operator can gradually increase the reception gain d in the direction of the AP 10 in the directional beam 200 of the STA 20 by operating the smartphone 30 such that the AP 10 can be visually recognized in the captured image 350 by gradually increasing the imaging magnification. Accordingly, the operator can cause the STA 20 to detect the AP 10 located at a distance, which is difficult to detect by the related-art pseudo omni pattern 110, by a simple operation. That is, it is possible to easily and efficiently perform work of wirelessly connecting the STA 20 to the AP 10 located farther from the STA 20.

The description returns to FIG. 6. When the wireless connection between the STA 20 and the AP 10 is completed, the operator selects (for example, taps) the completion button 353 through the input device 36 (step S19).

When detecting selection (for example, tapping) of the completion button 353, the smartphone 30 transmits a completion notification to the STA 20 (step S20).

Upon receiving the completion notification transmitted from the smartphone 30, the processor 21 of the STA 20 stores a current sector ID in the memory 22 (step S21). That is, the STA 20 determines an antenna pattern corresponding to the current sector ID for the directional beam 200 for wireless communication with the AP 10. Then, the processor 21 of the STA 20 ends the processing.

Through the above processing, the operator can easily adjust the reception range (reception angle θ) and the reception gain d of the directional beam 200 of the STA 20 by adjusting the imaging magnification of the camera 34 of the smartphone 30 connected to the STA 20, and can easily and efficiently perform the work of wirelessly connecting the STA 20 to the AP 10 located at a distant position.

The information indicating the imaging magnification of the camera 34 transmitted from the smartphone 30 to the STA 20 in step S14 in FIG. 6 is an example of information generated by an operation of changing the display of the captured image 350 performed by the user. For example, the information generated by the operation may include information indicating a change in the display of the captured image 350. For example, the information generated by the operation may include information indicating a degree of changing a reception range and a reception gain of a radio wave. For example, the information generated by the operation may include the sector ID corresponding to the imaging magnification. For example, the information generated by the operation may include parameters (for example, the gain value and the phase value of each antenna element) for setting the directional beam corresponding to the imaging magnification.

### (Summary of Present Disclosure)

The contents of the present disclosure can be expressed as follows.

### <Expression 1>

A communication system 1 includes: a wireless device (for example, an STA 20) configured to perform wireless connection with another wireless device (for example, an AP 10); and an information processing device (for example, a smartphone 30) connected to the wireless device. The information processing device displays a captured image 350 in which a reception direction of a radio wave of the wireless device is captured, and in a case that an operation of changing a display of the captured image 350 is performed by a user (for example, an operator), transmits information generated by the operation to the wireless device. The wireless device changes a reception range of the radio wave based on the information received from the information processing device. Accordingly, the user can easily change the reception range of the radio wave of the wireless device by performing the operation of changing the display of the captured image 350. Therefore, the user can efficiently perform work of wirelessly connecting the wireless device to another wireless device by adjusting the reception range of the radio wave of the wireless device such that a beacon transmitted from another wireless device can be received.

### <Expression 2>

In the communication system 1 described in Expression 1, the information generated by the operation may be information indicating a change in the display of the captured image. Accordingly, the wireless device can change the reception range of the radio wave based on the information indicating the change in the display of the captured image received from the information processing device.

### <Expression 3>

In the communication system 1 described in Expression 1, the information generated by the operation may be information indicating a degree of changing the reception range and a reception gain of the radio wave, and the wireless device may change the reception range and the reception gain of the radio wave based on the information indicating the degree of changing the reception range and the reception gain of the radio wave, the information being received from the information processing device. Accordingly, the wireless device can change the reception range and the reception gain of the radio wave based on the information indicating the degree of changing the reception range and the reception gain of the radio wave, the information being received from the information processing device.

### <Expression 4>

In the communication system 1 described in Expression 2, the operation of changing the display of the captured image 350 may be an operation of changing an imaging magnification of the captured image 350, the information indicating the change in the display of the captured image 350 may be information indicating the imaging magnification, and the wireless device may change the reception range and a reception gain of the radio wave based on the information indicating the imaging magnification received from the information processing device. Accordingly, the user can easily change the reception range and the reception gain of the radio wave of the wireless device by performing the operation of changing the imaging magnification of the captured image 350 of the information processing device. Therefore, the user can efficiently perform the work of wirelessly connecting the wireless device to another wireless device by adjusting the reception range and the reception gain of the radio wave of the wireless device such that the beacon transmitted from another wireless device can be received through the information processing device.

### <Expression 5>

In the communication system 1 described in Expression 4, the reception gain of the radio wave in a case that the imaging magnification is a first magnification may be larger than the reception gain of the radio wave in a case that the imaging magnification is a second magnification smaller than the first magnification. Accordingly, the user can increase the reception gain of the radio wave of the wireless device by performing an operation of increasing the imaging magnification.

### <Expression 6>

In the communication system 1 described in Expression 4, the wireless device may include conversion information 70 associating imaging magnifications with sector IDs indicating antenna patterns in which the reception ranges of the radio wave are different from each other, specify the sector ID corresponding to the imaging magnification received from the information processing device based on the conversion information 70, and change the reception range of the radio wave based on the antenna pattern indicated by the specified sector ID. Accordingly, the wireless device can specify the sector ID indicating the antenna pattern appropriate for the imaging magnification received from the information processing device. That is, the wireless device can set the reception range of the radio wave appropriate for the imaging magnification received from the information processing device.

### <Expression 7>

In a wireless connection method for wirelessly connecting a wireless device (for example, an STA 20) to another wireless device (for example, an AP 10), the wireless connection method includes: displaying, by an information processing device (for example, a smartphone 30), a captured image 350 in which a reception direction of a radio wave of the wireless device is captured, and in a case that an operation of changing a display of the captured image 350 is performed by a user and transmitting information generated by the operation to the wireless device, and changing, by the wireless device, a reception range of the radio wave based on the information received from the information processing device, and performing by the wireless device, wireless connection with another wireless device. Accordingly, a user can easily change the reception range of the radio wave of the wireless device by performing the operation of changing the display of the captured image 350 of the information processing device. Therefore, the user can easily and efficiently perform work of wirelessly connecting the wireless device to another wireless device by adjusting the reception range of the radio wave of the wireless device such that a beacon transmitted from another wireless device can be received.

### <Expression 8>

A wireless device (for example, an STA 20) configured to perform wireless connection with another wireless device (for example, an AP 10) includes: a plurality of antenna elements 40; and a processor 21 configured to, in response to receiving from a predetermined information processing device (for example, a smartphone 30) information generated by an operation of changing a display of a captured image 350 in which a reception direction of a radio wave received by an antenna element 44 is captured, change a reception range of the radio wave based on the received information. Accordingly, the wireless device can receive the information generated by the operation of changing the display of the captured image from the information processing device and change the reception range of the radio wave based on the received information. Therefore, a user can easily and efficiently perform work of wirelessly connecting the wireless device to another wireless device by adjusting the reception range of the radio wave of the wireless device such that a beacon transmitted from another wireless device can be received through the information processing device.

Although the embodiment has been described with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. Components in the above embodiment may be optionally combined within a range not departing from the spirit of the invention.

### INDUSTRIAL APPLICABILITY

The technology of the present disclosure is useful in a case that two wireless devices located far from each other are wirelessly connected to each other.

What is claimed is:

1. A communication system comprising:
a wireless device configured to perform wireless connection with another wireless device; and
an information processing device connected to the wireless device,
wherein the information processing device displays a captured image in which a reception direction of a radio wave of the wireless device is captured, and in a case that an operation of changing a display of the captured image is performed by a user, transmits information generated by the operation to the wireless device, and
wherein the wireless device changes a reception range of the radio wave based on the information received from the information processing device.

2. The communication system according to claim 1,
wherein the information generated by the operation is information indicating a change in the display of the captured image.

3. The communication system according to claim 1,
wherein the information generated by the operation is information indicating a degree of changing the reception range and a reception gain of the radio wave, and
wherein the wireless device changes the reception range and the reception gain of the radio wave based on the information indicating the degree of changing the reception range and the reception gain of the radio wave, the information being received from the information processing device.

4. The communication system according to claim 2,
wherein the operation of changing the display of the captured image is an operation of changing an imaging magnification of the captured image,
wherein the information indicating the change in the display of the captured image is information indicating the imaging magnification, and
wherein the wireless device changes the reception range and a reception gain of the radio wave based on the information indicating the imaging magnification received from the information processing device.

5. The communication system according to claim 4,
wherein the reception gain of the radio wave in a case that the imaging magnification is a first magnification is larger than the reception gain of the radio wave in a case that the imaging magnification is a second magnification smaller than the first magnification.

6. The communication system according to claim 4,
wherein the wireless device includes conversion information associating imaging magnifications with sector IDs indicating antenna patterns in which the reception ranges of the radio wave are different from each other, specifies the sector ID corresponding to the imaging magnification received from the information processing device based on the conversion information, and changes the reception range of the radio wave based on the antenna pattern indicated by the specified sector ID.

7. A wireless connection method for wirelessly connecting a wireless device to another wireless device, comprising:
displaying, by an information processing device, a captured image in which a reception direction of a radio wave of the wireless device is captured, and in a case that an operation of changing a display of the captured image is performed by a user and transmitting information generated by the operation to the wireless device; and
changing, by the wireless device, a reception range of the radio wave based on the information received from the information processing device, and performing, by the wireless device, wireless connection with another wireless device.

8. The wireless connection method according to claim 7,
wherein the information generated by the operation is information indicating a change in the display of the captured image.

9. The wireless connection method according to claim 7,
wherein the information generated by the operation is information indicating a degree of changing the reception range and a reception gain of the radio wave, and
wherein in the changing process, the reception range and the reception gain of the radio wave is changed based on the information indicating the degree of changing the reception range and the reception gain of the radio wave, the information being received from the information processing device.

10. The wireless connection method according to claim 8,
wherein the operation of changing the display of the captured image is an operation of changing an imaging magnification of the captured image,
wherein the information indicating the change in the display of the captured image is information indicating the imaging magnification, and
wherein in the changing process, the reception range and a reception gain of the radio wave is changed based on the information indicating the imaging magnification received from the information processing device.

11. The wireless connection method according to claim 10,
wherein the reception gain of the radio wave in a case that the imaging magnification is a first magnification is larger than the reception gain of the radio wave in a case that the imaging magnification is a second magnification smaller than the first magnification.

12. The wireless connection method according to claim 10,
wherein the wireless device includes conversion information associating imaging magnifications with sector IDs indicating antenna patterns in which the reception ranges of the radio wave are different from each other, specifies the sector ID corresponding to the imaging magnification received from the information processing device based on the conversion information, and changes the reception range of the radio wave based on the antenna pattern indicated by the specified sector ID.

13. A wireless device configured to perform wireless connection with another wireless device, the wireless device comprising:
a plurality of antenna elements; and
a processor configured to, in response to receiving from a predetermined information processing device information generated by an operation of changing a display of a captured image in which a reception direction of a radio wave received by the antenna element is captured, change a reception range of the radio wave based on the received information.

14. The wireless device according to claim 13,
wherein the information generated by the operation is information indicating a change in the display of the captured image.

15. The wireless device according to claim 13,
wherein the information generated by the operation is information indicating a degree of changing the reception range and a reception gain of the radio wave, and
wherein the processor changes the reception range and the reception gain of the radio wave based on the information indicating the degree of changing the reception range and the reception gain of the radio wave, the information being received from the information processing device.

16. The wireless device according to claim 14,
wherein the operation of changing the display of the captured image is an operation of changing an imaging magnification of the captured image,
wherein the information indicating the change in the display of the captured image is information indicating the imaging magnification, and
wherein the processor changes the reception range and a reception gain of the radio wave based on the information indicating the imaging magnification received from the information processing device.

17. The wireless device according to claim 16,
wherein the reception gain of the radio wave in a case that the imaging magnification is a first magnification is larger than the reception gain of the radio wave in a case that the imaging magnification is a second magnification smaller than the first magnification.

18. The wireless device according to claim 16, further comprising:
a memory configured to store conversion information associating imaging magnifications with sector IDs indicating antenna patterns in which the reception ranges of the radio wave are different from each other,
wherein the processor specifies the sector ID corresponding to the imaging magnification received from the information processing device based on the conversion information, and changes the reception range of the radio wave based on the antenna pattern indicated by the specified sector ID.
